(19) United States
(12) Patent Application Publication
(10) Pub. No.: US 2024/0134609 A1
(43) Pub. Date: Apr. 25, 2024

(54) EFFICIENT COMPUTATION OF A SHARED EXPONENT

(71) Applicant: NOKIA SOLUTIONS AND NETWORKS OY, Espoo (FI)

(72) Inventors: Mihaela Andreea JIVANESCU, Bierbeek (BE); Manil Dev GOMONY, Antwerp (BE); Roberto AIROLDI, Espoo (FI); Marko Timo Juhani KANGAS, Ylojarvi (FI)

(21) Appl. No.: 18/277,651

(22) PCT Filed: Feb. 1, 2022
(86) PCT No.: PCT/EP2022/052314

§ 371 Date: Aug. 16, 2023

(30) Foreign Application Priority Data
Feb. 18, 2021 (FI) 20215173

(51) Int. Cl. G06F 7/74

(52) U.S. Cl. CPC G06F 7/74

(57) ABSTRACT

Various example embodiments relate to computation of a shared exponent for numbers. A plurality of bit vectors may be obtained. A bitwise OR-operation may be performed for the plurality of bit vectors to obtain an auxiliary bit vector. The shared exponent may be then determined based on a position of a most significant bit having value equal to one in the auxiliary bit vector. The representation for the plurality of bit vectors may be then determined based on the shared exponent. Apparatuses, methods, and computer programs are disclosed.

### TECHNICAL FIELD

Various example embodiments generally relate to the field of computer science. In particular, some example embodiments relate to digital representation of numbers in data communication devices.

### BACKGROUND

In various computing devices, such as for example mobile phones, data comprising real-valued or complex-valued numbers may be represented by a fixed number of binary digits (bits), for example using the floating-point representation. Different compression algorithms may be used to reduce the amount of memory or communication resources for storage or transmission of the data.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may improve efficiency of compression of binary representation of numbers. This benefit may be achieved by the features of the independent claims. Further implementation forms are provided in the dependent claims, the description, and the drawings.

According to a first aspect, an apparatus may comprise means for obtaining a plurality of bit vectors; means for performing a bitwise OR-operation for the plurality of bit vectors to obtain an auxiliary bit vector; means for determining a shared exponent for representing the plurality of bit vectors based on a position of a most significant bit having value equal to one in the auxiliary bit vector; and means for determining a representation for the plurality of bit vectors based on the shared exponent.

According to an example embodiment of the first aspect, the apparatus may further comprise means for performing a bit-wise negation for bit vectors representing negative numbers.

According to an example embodiment of the first aspect, the means for performing the bit-wise negation of the bit vectors representing the negative numbers may comprise a plurality of multiplexers configured to output a non-negated version of an input bit vector, if a most significant bit of the input floating-point bit vector is equal to zero, and to output a bit-wise negated version of the input bit vector, if the most significant bit of the input floating-point-bit vector is equal to one.

According to an example embodiment of the first aspect, a length of the plurality of bit vectors may be N and the means for performing the bitwise OR-operation for the plurality of bit vectors may comprise a plurality of OR-gates having a width of N−1 bits.

According to an example embodiment of the first aspect, the plurality of bit vectors may represent real and/or imaginary parts of a plurality of modulation symbols.

According to an example embodiment of the first aspect, the plurality of modulation symbols may be associated with a physical layer resource block.

According to an example embodiment of the first aspect, the means may comprise: at least one processor; and at least one memory including computer program code, the at least one memory and computer program code configured to, with the at least one processor, cause the performance of the apparatus.

According to a second aspect, a method may comprise obtaining a plurality of bit vectors; performing a bitwise OR-operation for the plurality of bit vectors to obtain an auxiliary bit vector; determining a shared exponent for representing the plurality of bit vectors based on a position of a most significant bit having value equal to one in the auxiliary bit vector; and determining a representation for the plurality of bit vectors based on the shared exponent.

According to an example embodiment of the second aspect, the method may further comprise performing a bit-wise negation for bit vectors representing negative numbers.

According to an example embodiment of the second aspect, performing the bit-wise negation of the bit vectors representing the negative numbers may comprise outputting, by a plurality of multiplexers, a non-negated version of an input bit vector, if a most significant bit of the input bit vector is equal to zero, and to outputting a bit-wise negated version of the input bit vector if the most significant bit of the input-bit vector is equal to one.

According to an example embodiment of the second aspect, a length of the plurality of bit vectors may be N and performing the bitwise OR-operation for the plurality of bit vectors may be based on a plurality of OR-gates having a width of N−1 bits.

According to an example embodiment of the second aspect, the plurality of bit vectors may represent real and/or imaginary parts of a plurality of modulation symbols.

According to an example embodiment of the second aspect, the plurality of modulation symbols may be associated with a physical layer resource block.

According to a third aspect, a computer program may comprise instructions for causing an apparatus to perform at least the following: obtaining a plurality of bit vectors; performing a bitwise OR-operation for the plurality of bit vectors to obtain an auxiliary bit vector; determining a shared exponent for representing the plurality of bit vectors based on a position of a most significant bit having value equal to one in the auxiliary bit vector; and determining a representation for the plurality of bit vectors based on the shared exponent. The computer program may further comprise instructions for causing the apparatus to perform any example embodiment of the method of the second aspect.

According to a fourth aspect, an apparatus may comprise at least one processor and at least one memory including computer program code, the at least one memory and the computer code configured to, with the at least one processor, cause the apparatus at least to: obtain a plurality of bit vectors; perform a bitwise OR-operation for the plurality of bit vectors to obtain an auxiliary bit vector; determine a shared exponent for representing the plurality of bit vectors based on a position of a most significant bit having value equal to one in the auxiliary bit vector; and determine a representation for the plurality of bit vectors based on the shared exponent. The at least one memory and the computer code may be further configured to, with the at least one processor, cause the apparatus to perform any example embodiment of the method of the second aspect.

According to a fifth aspect, and apparatus may comprise circuitry configured to: obtain a plurality of bit vectors; perform a bitwise OR-operation for the plurality of bit vectors to obtain an auxiliary bit vector; determine a shared exponent for representing the plurality of bit vectors based on a position of a most significant bit having value equal to one in the auxiliary bit vector; and determining a representation for the plurality of bit vectors based on the shared exponent. The circuitry may be further configured to perform any example embodiment of the method of the second aspect.

Any example embodiment may be combined with one or more other example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a communication network, according to an example embodiment;

FIG. 2 illustrates an example of a resource block comprising resource elements, according to an example embodiment;

FIG. 3 illustrates an example of an apparatus configured to practice one or more example embodiments;

FIG. 4 illustrates an example of a bit vector compression algorithm based on maximum and minimum values, according to an example embodiment;

FIG. 5 illustrates an example of circuitry for determining the exponent of the largest signed number in a set of integers using 2's complement notation, according to an example embodiment;

FIG. 6 illustrates an example of a floating-point compression algorithm, based on a bit-wise OR operation, according to an example embodiment;

FIG. 7 illustrates an example of a multiplexer circuit, according to an example embodiment;

FIG. 8 illustrates an example of circuitry for determining the minimum number of bits for representing a set of positive and negative numbers based on a bitwise OR-operation, according to an example embodiment; and

FIG. 9 illustrates an example of a method for shared exponent computation, according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Floating point arithmetic enables to efficiently represent a large range of numbers by a fixed number of bits. In floating-point representation, the radix point is allowed to float within the so called significand (mantissa, coefficient) of the floating-point representation of the number (value) to be represented. The location of the radix point may be indicated by an exponent component of the floating-point representation. To find a suitable common type of floating-point representation for a set of values, for example a vector, a block, or an array of values, a shared (common) exponent among the set of values may be determined. A vector is used herein as an example of a set of values. A vector may therefore comprise a plurality of floating-point bit vectors. The shared exponent enables to reduce the required memory space, since the exponents do not need to be stored for each floating-point number separately.

Computing the shared exponent may be based on finding the maximum and minimum values among the values of an input vector. The values may be real or complex numbers. In case of complex numbers, the real and imaginary parts may be treated separately. Furthermore, the absolute maximum may used to compute the minimum number of bits required to represent the values in the vector without overflow. This information may be then used to shift and compress the vector values.

Example embodiments of the present disclosure may improve efficiency of floating-point compression by reducing complexity of determining the shared exponent. Bitwise OR-ing a block of input IQ-samples (in-phase and quadrature samples), optionally with bit-wise negation of negative values, may be used as an optimized alternative to finding the minimum and maximum, computing the absolute value of the minimum, and comparing it with the maximum. Instead, the position of the most significant bit equal to one (MSB1), for example the left-most “one”, of the output of the bit-wise OR may be used to calculate the shared exponent. The position of the most significant “one” provides the same result as the above minimum/maximum value based approach. From this point onward the computation of block floating point may continue in a similar way for both approaches. This OR-tree based approach to calculating the raw exponent may reduce the computational complexity significantly, resulting in significant latency, area, and power gains.

According to an example embodiment, a plurality of bit vectors may be obtained. A compressed representation for these bit vectors may be determined based on single exponent shared by the bit vectors. A bitwise OR-operation may be performed for the plurality of bit vectors to obtain an auxiliary bit vector. The shared exponent may be then determined based on a position of a most significant bit having value equal to one in the auxiliary bit vector. The representation for the plurality of bit vectors may be then determined based on the shared exponent. If the bit vectors are in two's complement representation, the apparatus may bit-wise negate bit vectors representing negative numbers prior to determining the shared exponent as described above.

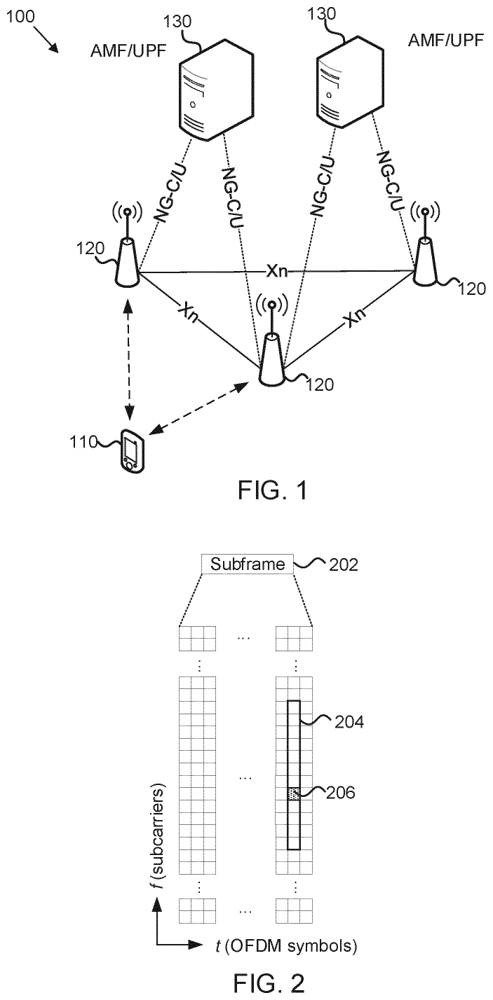

FIG. 1 illustrates an example of a communication network, according to an example embodiment. The communication network 100 may comprise one or more core network elements such as for example access and mobility management function (AMF) and/or user Plane function (UPF) 130, one or more base stations, represented by gNBs 120. The communication network 100 may further comprise one or more devices, which may be also referred to as a user nodes or user equipment (UE). UE 110 may communicate with one or more of the base stations via wireless radio channel(s). Communications between UE 110 and gNB(s) 120 may be bidirectional. Hence, any of these devices may be configured to operate as a transmitter and/or a receiver.

The base stations may be configured to communicate with the core network elements over a communication interface, such as for example a control plane interface or a user plane interface NG-C/U. Base stations may be also called radio access network (RAN) nodes and they may be part of a radio access network between the core network and the UEs. Functionality of a base station may be distributed between a central unit (CU), for example a gNB-CU, and one or more distributed units (DU), for example gNB-DUs. Network elements AMF/UPF 130, gNB 120, gNB-CU, or gNB-DU may be generally referred to as network nodes or network devices. Although depicted as a single device, a network node may not be a stand-alone device, but for example a distributed computing system coupled to a remote radio head. For example, a cloud radio access network (cRAN) may be applied to split control of wireless functions to optimize performance and cost.

The communication network 100 may be configured for example in accordance with the 5th Generation digital cellular communication network, as defined by the 3rd Generation Partnership Project (3GPP). In one example, the communication network 100 may operate according to 3GPP 5G-NR (5G New Radio). The communication network may be also configured according to Open Radio Access Network (O-RAN) standard(s) specified by the O-RAN Alliance. It is however appreciated that example embodiments presented herein are not limited to devices configured to operate under these example networks and the example embodiments may be applied in any devices using floating-point arithmetic, for example devices configured to operate in any present or future wireless or wired communication networks, or combinations thereof, for example other type of cellular networks, short-range wireless networks, broadcast or multicast networks, or the like. It is also noted that the example embodiments may be generally applied in any computing devices, regardless of whether they provide connectivity to other devices over a communication network.

FIG. 2 illustrates an example of a resource block comprising resource elements, according to an example embodiment. A subframe 202 may comprise a plurality of orthogonal frequency division multiplexing (OFDM) symbols. An OFDM symbol may comprise a plurality of subcarriers. Each subcarrier may be modulated by a scheme, such as for example quadrature amplitude modulation (QAM) or phase shift keying (PSK). A subframe may comprise a plurality of resource blocks (RB) 204. A RB 204 may comprise a plurality of resource elements (RE) 206. A RE 206 may comprise one subcarrier at one OFDM symbol. A RE 206 may therefore carry one modulated symbol. A RB 204 may comprise a set of REs 206 associated with one or more OFDM symbols.

Modulated symbols may be selected based on mapping binary input strings to particular modulation symbols of a constellation, for example a QAM or PSK constellation. In general, a constellation may comprise a set of possible complex-valued modulation symbols. A modulation symbol may be therefore represented by two real numbers, I- and Q-components, corresponding to the real and imaginary parts of the complex-valued modulation symbol, respectively. However, in case of binary phase shift keying (BPSK), a modulation symbol may be purely real-valued or purely imaginary-valued. In this case, a modulation symbol may be represented by one real number.

In general, data communication may be arranged in blocks of data, for example blocks of modulated symbols. An example of such data block is the resource block (RB) 204, which may be configured for example according to the 5G NR system. Since the resource block is defined with respect to physical layer resources (subcarriers and OFDM symbols), the resource block 204 may be called a physical (layer) resource block (PRB).

In the example of FIG. 2, the resource block 204 comprises twelve subcarriers (REs) in one OFDM symbol. The modulated symbols carried by the REs 206s may be represented using a binary representation. It is however noted that the RB 204 is just one example of a data block, for which a bit vector compression may be performed jointly, and therefore the example embodiments may be applied to any types of blocks or sets of complex- or real-valued numbers.

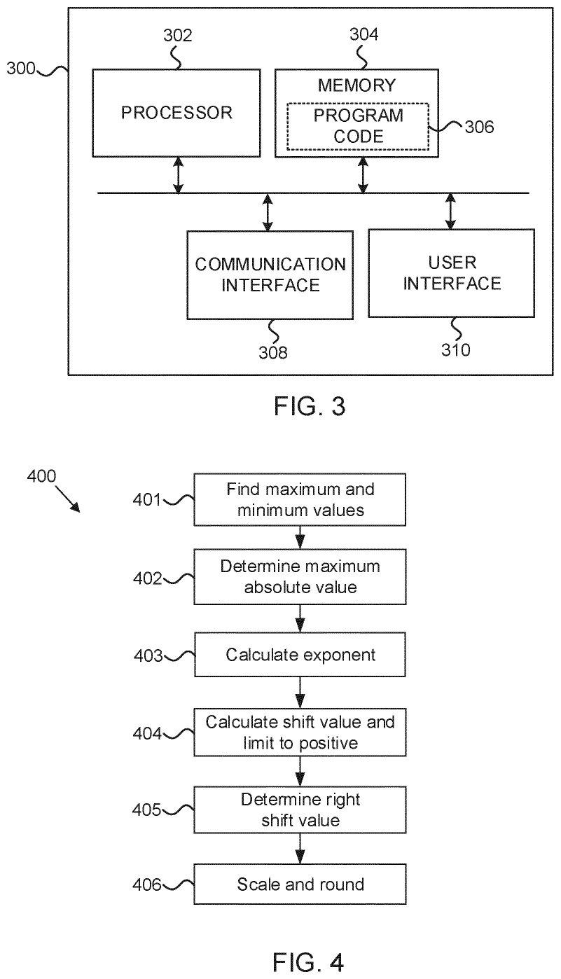

FIG. 3 illustrates an example embodiment of an apparatus 300, for example a computing device such as UE 110 or gNB 120. The apparatus 300 may comprise at least one processor 302. The at least one processor 302 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware (HW) accelerator, a special-purpose computer chip, or the like.

The apparatus 300 may further comprise at least one memory 304. The at least one memory 304 may be configured to store, for example, computer program code or the like, for example operating system software and application software. The at least one memory 304 may comprise one or more volatile memory devices, one or more non-volatile memory devices, and/or a combination thereof. For example, the at least one memory 304 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 300 may further comprise a communication interface 308 configured to enable apparatus 300 to transmit and/or receive information to/from other devices. In one example, apparatus 300 may use communication interface 308 to transmit or receive signaling information and data in accordance with at least one cellular communication protocol. The communication interface may be configured to provide at least one wireless radio connection, such as for example a 3GPP mobile broadband connection (e.g. 3G, 4G, 5G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 308 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

The apparatus 300 may further comprise a user interface 210 comprising an input device and/or an output device. The input device may take various forms such a keyboard, a touch screen, or one or more embedded control buttons. The output device may for example comprise a display, a speaker, a vibration motor, or the like.

When the apparatus 300 is configured to implement some functionality, some component and/or components of the apparatus 300, such as for example the at least one processor 302 and/or the at least one memory 304, may be configured to implement this functionality. Furthermore, when the at least one processor 302 is configured to implement some functionality, this functionality may be implemented using the program code 306 comprised, for example, in the at least one memory 304.

The functionality described herein may be performed, at least in part, by one or more computer program product components such as software components. According to an embodiment, the apparatus comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

The apparatus 300 comprises means for performing at least one method described herein. In one example, the means comprises the at least one processor 302, the at least one memory 304 including program code 306 configured to, when executed by the at least one processor, cause the apparatus 300 to perform the method.

The apparatus 300 may comprise for example a computing device such as for example a base station, a server, a mobile phone, a tablet computer, a laptop, an internet of things (IoT) device, or the like. Examples of IoT devices include, but are not limited to, consumer electronics, wearables, sensors, and smart home appliances. In one example, the apparatus 300 may comprise a vehicle such as for example a car. Although apparatus 300 is illustrated as a single device it is appreciated that, wherever applicable, functions of the apparatus 300 may be distributed to a plurality of devices, for example to implement example embodiments as a cloud computing service.

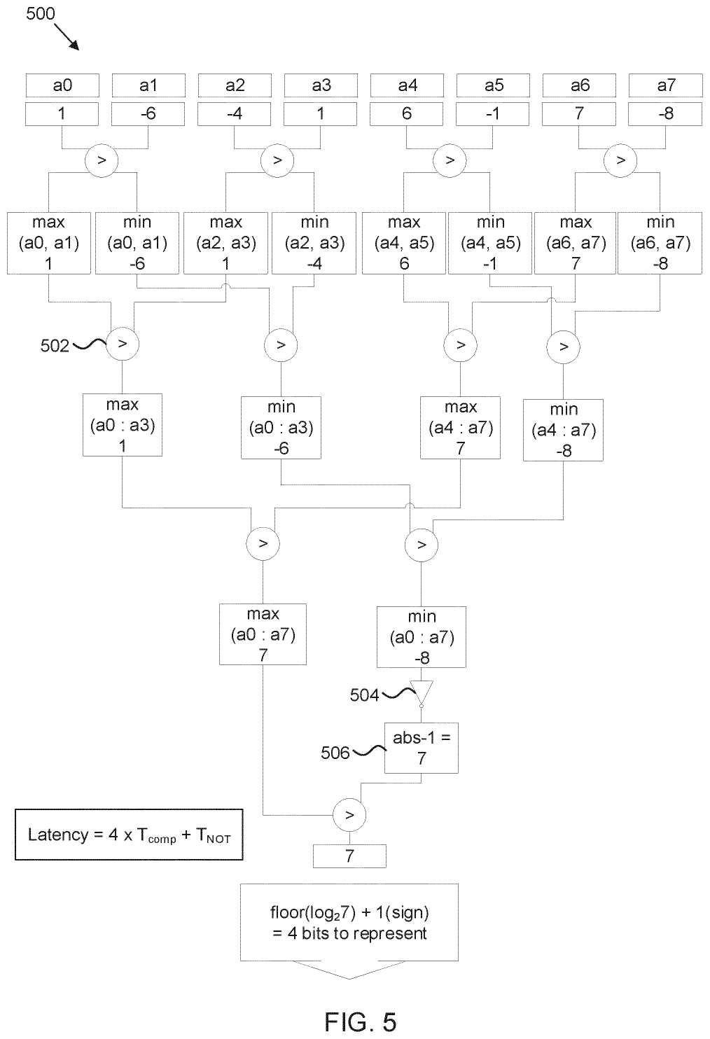

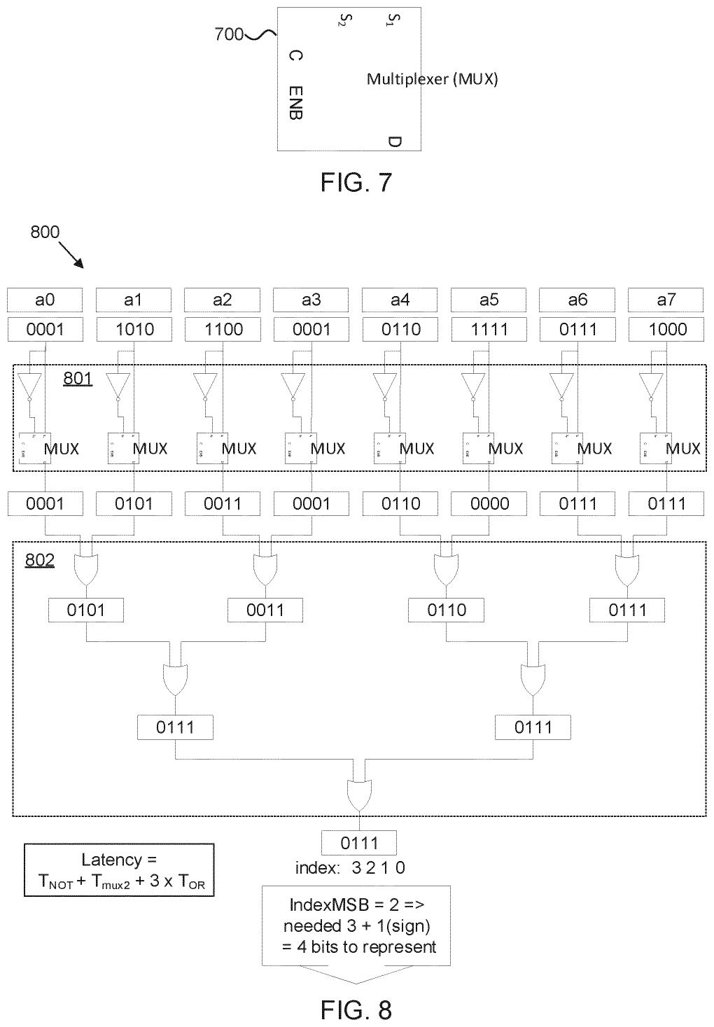

Example embodiments may also be implemented with circuitry, such as for example digital logic circuitry, without the processor/memory structure of FIG. 3. The example embodiments are therefore applicable both to a hard-wired implementation or as dedicated instructions in a custom processor, e.g. an application specific instruction processor (ASIP). Examples of a hard-wired circuitry for determining the shared exponent are provided in FIG. 5 and FIG. 7.

FIG. 4 illustrates an example of a block compression algorithm, according to an example embodiment. The block compression algorithm 400 may be for example used to compress a block of binary vectors or values in an O-RAN system. The algorithm 400 may therefore comprise a block floating point compression algorithm.

At operation 401, a device, for example UE 110, gNB 120, or apparatus 300, may find maximum and minimum values within a block of data. The block of data may comprise for example IQ-samples corresponding to modulation symbols of a physical resource block (PRB). For example, operation 401 may provide as its output the maximum (maxV) and minimum (minV) values within the data block, where

maxV=max(Re(fPRB),Im(fPRB)),

minV=min(Re(fPRB),Im(fPRB)),

where Re and Im denote the real and imaginary parts, respectively, and fPRB comprises binary vector representations of the resource block 202.

At operation 402, the device may determine a maximum absolute value. For example, the device may determine the maximum absolute value (maxValue) within the resource block 202 based on

maxValue=max(maxV,|minV|−1),

where |·| denotes the absolute value. The subtraction |minV|−1 may be performed since the most significant bit of a negative value may be one higher.

At operation 403, the device may calculate an exponent (a raw exponent, raw_exp). Calculation of the exponent may be based on the determined maximum absolute value, for example by

raw_exp=[floor(log₂(maxValue)+1)](msb of maxValue).

At operation 404, the device may calculate a shift value and limit to positive. This may be based on the exponent (raw_exp) calculated at operation 403. The device may for example calculate

exponent=max(raw_exp−iqWidth+1,0).

At operation 405, the device may determine a right shift value. For example, the device may determine a scaling factor (scaler) for quantization of the data based on

scaler=2^{-exponent}.

At operation 406, the device may perform scaling and rounding. This operation may provide as output the quantized real and imaginary parts for the modulated symbols of the physical resource block (PRB). However, as discussed above, the data block may comprise real-valued modulation symbols. The data may be also any other data. To quantize the modulation symbols, the device may iteratively quantize the real and imaginary parts of the modulation symbols, for example based on

```
for iRe = 1:length(fPRB)
  // Scale and round
  Re(cPRB(iRE)) = Quantize (scaler x Re(fPRB(iRE)))
  Im(cPRB(iRE)) = Quantize (scaler x Im(fPRB(iRE)))
end.
```

Herein, the multiplication may be implemented by a bit-shift. The Quantize-operation may comprise an or-round or any other rounding scheme.

However, using this approach the maximum and minimum values may need to be computed for all values in the input block. This may result in unnecessary consumption of important resources such as time, power, and silicon area. Computing the shared exponent is generally a laborious task and therefore the efficiency of procedure of FIG. 4 may be further improved.

FIG. 5 illustrates an example of circuitry for determining the exponent of the largest signed number in a set of integers, using 2's complement notation, according to an example embodiment. The circuitry 500 may be used to implement the block compression algorithm 400. The block a0:a7 is an example of an input block comprising multiple input integer bit vectors. The input block may represent either eight real-valued numbers or four complex-valued numbers. Example values [1, −6, −4, 1, 6, −1, 7, −8] have been provided in decimal format for simplicity. A set of possible values are shown for each step of the computation. For an eight-element vector, there may be four levels of comparators 502 (“>”), resulting ibn additional latency of 4×T_{COMP}, where T_{COMP} is the latency of one comparator 502. Considering silicon area and power consumption, there are in total eleven individual numeric comparators. On top of this there may be a (4-bit wide) negation gate 504 in the critical path.

The data of the input vector is propagated through the four levels of comparators, taking either a maximum or minimum value at the output of the first three layers, with the negation gate 504 and the “abs−1” operation 506 on one of the paths before the lowest layer comparison. The output of the algorithm may be obtained by floor(log₂7)+1 (sign). This gives four bits as the minimum number of bits required to represent the input vector without loss. The resulting latency is 4×T_{COMP}+T_{NOT}, where T_{NOT} is the latency of the negation gate 504. For these reasons, computing the shared exponent may be costly in terms of latency, silicon area, power consumption.

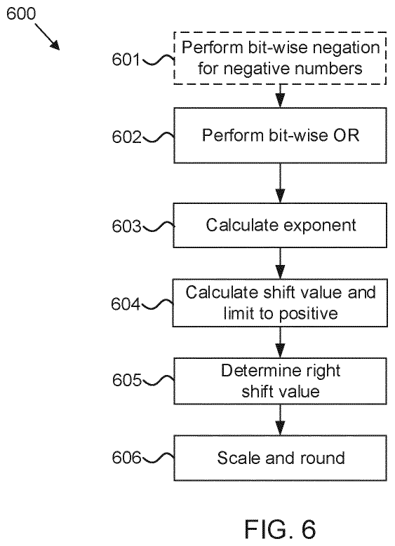

FIG. 6 illustrates an example of a block compression algorithm, based on a bit-wise OR operation, according to an example embodiment. Mantissas may be represented using a sign-magnitude representation, where the sign is indicated by one bit, for example the most significant bit, and the remaining bits indicate the magnitude (absolute value). Alternatively, mantissas may be represented using the two's complement representation that avoids allocating two different representations for zero. In two's complement, a mantissa may be negated by negating all bits of the binary representation and adding one to the resulting bit vector. Algorithm 600 may take different forms, for example depending on whether a bit vector comprises a sign-magnitude or two's complement representation. Inputs of the block compression algorithm 600 may comprise integers, for example in 2's complement or sign-magnitude representation. The algorithm 600 may be however also applied to not normalized floating point. Herein, normalization may refer to a representation where mantissas of normal floating point numbers are already maximum shifted left and the MSB1 is omitted from the representation. Algorithm 600 may be performed by a device, for example UE 110, gNB 120, or apparatus 300, which may initially obtain a plurality of bit vectors for compression. As discussed above, the bit vectors may represent real and/or imaginary parts of modulation symbols, for example modulation symbols of one or more physical resource blocks.

At operation 601, the device may perform bit-wise negation for negative numbers, i.e., for bit vectors representing negative numbers. Hence, each bit of a bit vector may be negated (inverted) if the bit vector represents a negative number (<0). If the bit vector represents a non-negative number (>0), the bit vector may be passed on as it is without negation of any of its bits. Operation 601 may be performed in case of two's complement representation of the bit vectors. In case of sign-magnitude representation this operation may be omitted.

At operation 602, the device may perform a bit-wise OR operation for the plurality of bit vectors. A bit-wise OR operation may comprise determining whether at least one of the bits of the plurality of bit vectors at a particular bit position is non-zero. If there's at least one non-zero bit, the corresponding bit at the output of the bit-wise OR operation may be set to one. The output of the bit-wise OR operation may comprise an auxiliary bit vector, which may be subsequently used to calculate an exponent in operation 603.

At operation 603, the device may calculate an exponent. The exponent, which may correspond to the raw exponent of algorithm 400, may be determined based on a position (IndexMSB) of a most significant bit having value equal to one in the auxiliary bit vector. For example, if the bit positions are indexed starting from “0”, corresponding to the least significant bit (LSB), the number of bits to represent may be determined by adding two to the index of the most significant one (+1 due to index starting form “0” and +1 for sign)

N_bits=IndexMSB+2.

For example, if the auxiliary bit vector is equal to “0111” (MSB on the left, with position indices [3 2 1 0]), then IndexMSB=2 and the number of bits to represent, which is equivalent to the (raw) exponent, may be determined by N_bits=IndexMSB+2=2+2=4. The device may then determine a representation for the plurality of bit vectors based on the calculated exponent. Each of the plurality of bit vectors may be represented using the same (shared/common) exponent. The determined representation may therefore comprise one exponent for the plurality of floating-point bit vectors.

At operations 604 to 606, the device may determine a compressed representation for the plurality of floating-point bit vectors based on the calculated exponent. Operations 604 to 606 may be similar to operations 405 to 406, respectively. The output format of the block compression algorithm 600 may therefore be a block floating point format with a shared or common exponent and aligned mantissas to that shared or common exponent.

FIG. 7 illustrates an example of a multiplexer circuit, according to an example embodiment. The multiplexer circuit 700 may be used for efficient implementation operation 601 of the algorithm 600. The multiplexer 700 may comprise first and second data inputs S₁ and S₂, a data output D, a control input C, and an enable input EN. One or more of the above inputs may be optional and practical implementations may vary. Setting the enable input EN may enable operation of the multiplexer 700. During operation, the control input may be used to control, which of the data inputs S₁ and S₂ is connected to the data output D. For example, setting the control input to logical high may cause the first data input S₁ to be forwarded to the data output D. And, setting the control input to logical low may cause the second data input S₂ to be forwarded to the data output D.

FIG. 8 illustrates an example of circuitry for determining the minimum number of bits for representing a set of positive and negative numbers based on a bitwise OR-operation, according to an example embodiment. The circuitry 800 provides an example of a hard-wired implementation for calculating a shared exponent for an eight-value input. The input vector [a0:a7] may comprise bit vectors (input bit vectors), in this example with values 0001, 1010, 1100, 001, 0110, 1111, 0111, and 1110. These values correspond to the input values of FIG. 5, but in binary format, using 2's complement representation.

The circuitry 800 may comprise a negation and multiplexing stage 801. Each input bit vector may be passed through a NOT-stage followed by a multiplexer. The multiplexers may be similar to multiplexer 700. The negation and multiplexing stage 801 may comprise NOT-gates (invertors) for bit-wise negating one input of the multiplexers. The multiplexers may be configured to select between the initial value of the input bit vector or its 1's complement (bit-wise negation), for example depending on the MSB of each of the input values. Each multiplexer may therefore take as input the input vectors both as bit-wise negated and non-negated, for example at inputs S₁ and S₂ of the multiplexer 700. The MSBs of the input bit vectors may be coupled to the control inputs C of the multiplexers. For example, if the value of the MSB is equal to zero, the multiplexer may forward the original input bit vector. If the value of the MSB is equal to one, the multiplexer may forward the negated input bit vector (i.e., 1's complement). The output bit vectors 0001, 0101, 0011, 0001, 0110, 000, 0111, and 0111 of the negation and multiplexing stage are illustrated also illustrated in FIG. 8. The negation and multiplexing stage 801 may be used if the input bit vectors are in two's complement representation. The multiplexing stage 801 may not be present, or it may be bypassed, for the sign-magnitude representation. The negation and multiplexing stage 801 may be used to implement operation 601 of the algorithm 600.

The circuitry 800 may comprise an OR-tree 802. In the example of an eight-value input, the OR-tree 802 may comprise three levels of OR-gates. The OR-tree may be used to calculate a bit-wise OR between its input bit vectors, for example the output bit vectors of the negation and multiplexing stage 801 or the bit vectors of the input vector [a0:a7] directly. At each OR-tree level, one or more OR-operations may be performed between two input bit vectors and the result of the OR operation(s) may be passed to the next OR-level or provided as an output of the OR-tree 802. As illustrated in FIG. 8, the first OR-tree level may perform four OR-operations for four pairs of the eight input bit vectors. The OR-gates of the first OR-tree level may calculate a bit-wise OR between input bit vectors 0001 and 0101, 0011 and 0001, 0110 and 0000, and 0111 and 0111, resulting in four output bit vectors 0101, 0011, 0110, and 0111, respectively. The second OR-tree level may perform two OR-operations for two pairs of the four output bit vectors of the first OR-tree level. The OR-gates of the second OR-tree level may therefore calculate a bit-wise OR between bit vectors 0101 and 0011, and 0110 and 0111, resulting in two output bit vectors 0111 and 0111, respectively. The third OR-tree level may perform one OR-operation for two output vectors of the second OR-tree level. The OR-gate of the third OR-tree level may therefore calculate a bit-wise OR between bit vectors 0111 and 0111, resulting in an output bit vector 0111.

The output bit vector of the OR-tree may be indexed with position indices [3 2 1 0] (MSB left). The output bit vectors may be used to detect the position of the most significant one. In this example, the index of the most significant one is IndexMSB=2 and the number of bits to represent may be determined by N_bits=IndexMSB+2=2+2=4. This position may be used to compute the shift for all values in the vector [a0:a7], for example as in operations 405 or 605. The shared exponent may be then determined similar to operation 605. The resulting latency is T_{NOT}+T_{MUX2}+3×T_{OR}, where T_{NOT} and T_{MUX2} are the latency of the negation gates and the latency of the two-input multiplexers of the negation and multiplexing stage 801, and T_{OR} is the latency of an OR-gate of the OR-tree 802, while 3 is the number of OR-stages required for the number of inputs considered for this embodiment.

As described above, the MSB of each of the input bit vectors may be used for at corresponding multiplexer to determine whether the original or negated input is forwarder. Therefore, the OR and NOT gates may be configured not to consider the MSB and the width of the OR and/or the NOT gates may be reduced to further reduce complexity. For example, if the length of the plurality of bit vectors is N, the OR-gates and/or the NOT gates may have a width of N−1 bits.

The following table provides a comparison of the number of different components needed for the implementation of the architectures of FIG. 5 and FIG. 8 for eight signed values, each input being N-bits wide. For each approach, generalized numbers are presented on the left column, and the number corresponding to the eight-value input vector [a0:a7] of FIG. 5 and FIG. 8 are listed on the right column for each circuitry. The OR- and NOT-gates and the multiplexers that might be used inside the implementation of the comparators (“>”) are not counted separately for circuitry 500. The first four rows in the table indicate the resources that influence the silicon area and power consumption, and the fifth row indicates the latency for the two example circuitries. The number of resources is linearly proportional with the number of the plurality of the input floating-point bit vectors (M) to be represented with a shared exponent. The latency is proportional with log₂M. The width of the resources is determined by the number of bits of the input bit vectors.

| | Circuitry 800 | | Circuitry 500 | |
|---|---|---|---|---|
| | | Example | | Example |
| | | (8-value | | (8-value |
| Resources | General | input) | General | input) |
| Comparators | — | — | 3M/2 − 1 | 11 |
| (N bits) | | | | |
| OR-gates | M − 1 | 7 | — | — |
| (N − 1 bits) | | | | |
| NOT-gates | M | 8 | 1 | 1 |
| (N − 1 bits) | | | | |
| Multiplexers | M | 8 | — | — |
| (MUX2) | | | | |
| Latency | T_{NOT} + | T_{NOT} + | (1 + | 4 × |
| | T_{MUX2} + | T_{MUX2} + | log₂M) × | T_{COMP} + |
| | (log₂M) × | 3 × T_{OR} | T_{COMP} + | T_{NOT} |
| | T_{OR} | | T_{NOT} | |

When implementing the example embodiments on a processor, such as for example ASIP or other custom processor, one instruction may be used to cause computation of the shared exponent for a set of both positive and negative numbers at the same time. This improves efficiency of floating-point compression. Using the bit-wise OR based algorithm, for example the circuitry 800, the whole shared exponent, including the computation of the scaling factor/shared exponent and the effective shift of the elements of the input bit vector may be computed in a single clock period, and thus the whole compression into a block shared exponent may be contained in a single clock instruction. The time may be logarithmically proportional with M. Therefore, the disclosed methods are suitable for example for compressing modulation symbols of a physical resource block by applying one shared exponent for their representation.

Thus, a first observation is related to the types of resources required between the two circuitries, comparators for circuitry 500 and basic gates (NOT, OR) for circuitry 800. Hence, circuitry 800 may be implemented with simpler gates resulting in smaller silicon area. Another observation is that the scaling of the resources with respect to M is different between the two circuitries. Latency is another factor that makes a difference between the two approaches. The latency of a single comparator (T_{COMP}) increases with the number of bits at input (N), while the latency T_{OR} stays the same. For circuitry 800, the latency only scales with the number of floating-point bit vectors in the same input block (targeted for same shared exponent), thus the latency is the same for 8×4-bit input and 8×32-bit input. However, the latency of circuitry 500 scales with both the number of input bit vectors and the number of bits in these bit vectors (through the comparator latency). Hence, the circuitry 800 is more suitable for handling larger blocks of input floating-point bit vectors. Furthermore, the width of the OR and NOT gates of circuitry 800 may be N−1, which further reduces complexity.

Below is an example of an implementation of the bit-wise OR based computation of the shared exponent in a hardware register transfer level description language. Registers DI0, DQ0, DI1, DQ1 may contain I- and Q-components of two resource elements (RE) of a physical resource block (PRB). Signals NI0, NQ0, NI1, NQ1 may contain the original input value or the inverted value of each complex component. Register PATTERN may cumulate the OR'd result of the REs of one PRB. Asserted control signal PRB_START may be used to mark the start of a new PRB. When PRB_START is asserted, the cumulation of PATTERN is started again from each bit having an initial value of zero.

| architecture RTL of BEAM_PACK is | |
|---|---|
| -- Declare data vector signals. | |
| signal DI0, DQ0, DI1, DQ1 | : std_logic_vector (15 downto 0); |
| signal NI0, NQ0, NI1, NQ1 | : std_logic_vector (15 downto 0); |
| signal PATTERN | : std_logic_vector (15 downto 0); |
| signal EXPONENT | : std_logic_vector ( 3 downto 0); |

```
begin
-- Forward 2's complement data D* to N*. Negate if negative.
NI0 <= DI0 when (DI0(15) = ′0′) else not DI0;
NQ0 <= DQ0 when (DQ0(15) = ′0′) else not DQ0;
NI1 <= DI1 when (DI1(15) = ′0′) else not DI1;
NQ1 <= DQ1 when (DQ1(15) = ′0′) else not DQ1;
-- Construct OR'd Bit Pattern.
CONSTRUCT : process (CK)
begin
if (CK′event and CK = ′1′) then
  if (PRB_START = ′1′) then
    PATTERN <= NI0 or NQ0 or NI1 or N1;
  elsif (PRB_START = ′0′) then
    PATTERN <= PATTERN
      or NI0 or NQ0 or NI1 or NQ1;
  end if;
end if;
end process CONSTRUCT;
```

The following example code provides an example of using the most significant non-zero bit of the constructed OR'd bit pattern image PATTERN for selecting the common exponent output signal EXPONENT for the PRB together with the configured mantissa width CONFIG_BIT_WIDTH, for example for exchanging over the O-RAN interface in the uplink data direction.

```
-- Convert Bit Pattern to Exponent.
CONVERT : process(CONFIG_BIT_WIDTH, PATTERN)
begin
  -- Default.
  EXPONENT <= (others => ‘0’);
  -- Float.
  for I in 0 to 14 loop
    if ((I >= CONFIG_BIT_WIDTH) and (PATTERN(I) = ‘1’)) then
      EXPONENT <= I + 1 − CONFIG_BIT_WIDTH;
    end if;
  end loop;
end process CONVERT;
end RTL;
```

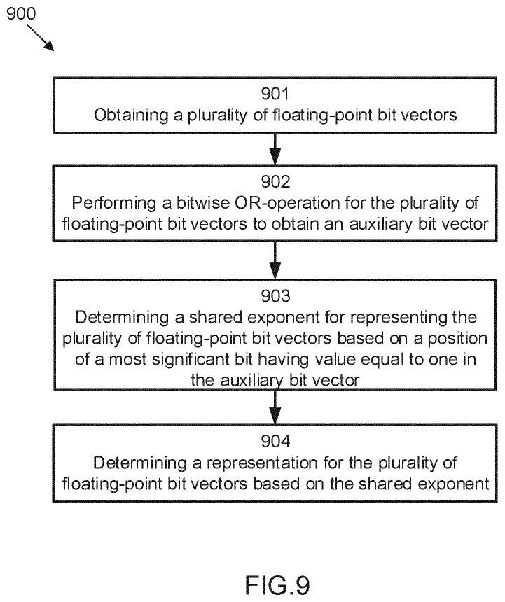

FIG. 9 illustrates an example of a method for shared exponent computation, according to an example embodiment.

At 901, the method may comprise obtaining a plurality of bit vectors.

At 902, the method may comprise performing a bitwise OR-operation for the plurality of bit vectors to obtain an auxiliary bit vector.

At 903, the method may comprise determining a shared exponent for representing the plurality of bit vectors based on a position of a most significant bit having value equal to one in the auxiliary bit vector.

At 904, the method may comprise determining a representation for the plurality of bit vectors based on the shared exponent.

Further features of the method directly result from the functionalities and parameters of the UE 110, the gNB(s) 120, or the apparatus 300, as described in the appended claims and throughout the specification, and are therefore not repeated here. Different variations of the method may be also applied, as described in connection with the various example embodiments. An apparatus, for example the UE 110, or a network node such as gNB 120 may be configured to perform or cause performance of any aspect of the method(s) described herein. Further, a computer program or a computer program product may comprise instructions for causing, when executed, an apparatus to perform any aspect of the method(s) described herein. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s). An apparatus may therefore comprise at least one processor, and at least one memory including program code, the at least one processor, and program code configured to, when executed by the at least one processor, cause the apparatus to perform any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1.-6. (canceled)

7. A method, comprising:
obtaining a plurality of bit vectors;
performing a bitwise OR-operation for the plurality of bit vectors to obtain an auxiliary bit vector;
determining a shared exponent for representing the plurality of bit vectors based on a position of a most significant bit having value equal to one in the auxiliary bit vector; and
determining a representation for the plurality of bit vectors based on the shared exponent.

8. The method according to claim 7, further comprising:
performing a bit-wise negation for bit vectors representing negative numbers.

9. The method according to claim 8, wherein performing the bit-wise negation of the bit vectors representing the negative numbers comprises outputting, by a plurality of multiplexers, a non-negated version of an input bit vector, if a most significant bit of the input bit vector is equal to zero, and to outputting a bit-wise negated version of the input bit vector if the most significant bit of the input-bit vector is equal to one.

10. The method according to claim 9, wherein a length of the plurality of bit vectors is N, and wherein performing the bitwise OR-operation for the plurality of bit vectors is based on a plurality of OR-gates having a width of N−1 bits.

11. The method according to claim 7, wherein the plurality of bit vectors represent real and/or imaginary parts of a plurality of modulation symbols.

12. The method according to claim 11, wherein the plurality of modulation symbols are associated with a physical layer resource block.

13. A non-transitory computer-readable medium including computer program instructions encoded thereon that, when executed on an apparatus cause the apparatus to perform at least the following:
obtaining a plurality of bit vectors;
performing a bitwise OR-operation for the plurality of bit vectors to obtain an auxiliary bit vector;
determining a shared exponent for representing the plurality of bit vectors based on a position of a most significant bit having value equal to one in the auxiliary bit vector; and
determining a representation for the plurality of bit vectors based on the shared exponent.

14. An apparatus comprising:
at least one processor; and
at least one memory including computer program code;
the at least one memory and the computer program code configured to, with the at least one processor, cause the apparatus at least to perform:
obtaining a plurality of bit vectors;
performing a bitwise OR-operation for the plurality of bit vectors to obtain an auxiliary bit vector;
determining a shared exponent for representing the plurality of bit vectors based on a position of a most significant bit having value equal to one in the auxiliary bit vector; and
determining a representation for the plurality of bit vectors based on the shared exponent.

15. The apparatus according to claim 14, wherein at least one memory and computer program code further cause the apparatus to at least:
perform a bit-wise negation for bit vectors representing negative numbers.

16. The apparatus according to claim 15, wherein performing the bit-wise negation of the bit vectors representing the negative numbers comprises outputting, by a plurality of multiplexers, a non-negated version of an input bit vector, if a most significant bit of the input bit vector is equal to zero, and outputting a bit-wise negated version of the input bit vector if the most significant bit of the input-bit vector is equal to one.

17. The apparatus according to claim 16, wherein a length of the plurality of bit vectors is N, and wherein performing the bitwise OR-operation for the plurality of bit vectors is based on a plurality of OR-gates having a width of N−1 bits.

18. The apparatus according to claim 14, wherein the plurality of bit vectors represent real and/or imaginary parts of a plurality of modulation symbols.

19. The apparatus according to claim 18, wherein the plurality of modulation symbols are associated with a physical layer resource block.

20. An apparatus configured to perform the method of claim 7.

21. The apparatus according to claim 14, wherein the plurality of bit vectors represent real and/or imaginary parts of a plurality of modulation symbols.

22. The apparatus according to claim 14, wherein the representation for the plurality of bit vectors comprises a block floating point format with a shared exponent and aligned mantissas to the shared exponent.

23. The apparatus according to claim 22, wherein the mantissas are represented using a sign-magnitude representation or a two's complement representation.

24. The method according to claim 7, wherein the plurality of bit vectors represent real and/or imaginary parts of a plurality of modulation symbols.

25. The method according to claim 7, wherein the representation for the plurality of bit vectors comprises a block floating point format with a shared exponent and aligned mantissas to the shared exponent.

26. The method according to claim 25, wherein the mantissas are represented using a sign-magnitude representation or a two's complement representation.
